(19) United States
(12) Patent Application Publication
(10) Pub. No.: US 2010/0060421 A1
(43) Pub. Date: Mar. 11, 2010

(54) RFID TAG WITH A SEMI-ENCLOSED COUPLER

(76) Inventors: CHIH-CHEN CHANG, Panchiau (TW); Sui-Feng Lu, Hsinchu (TW)

Correspondence Address: Dr. BANGER SHIA, 102 Lindencrest Ct., Sugar Land, TX, 77479-5201, US

(21) Appl. No.: 12/206,694

(22) Filed: Sep. 8, 2008

(51) Int. Cl. H04Q 5/22

(52) U.S. Cl. 340/10.1

(57) ABSTRACT

A RFID tag with a semi-enclosed coupler, wherein the coupler of the antenna layer is designed to be a semi-enclosed linear structure, and the open end of the coupler is connected to the antenna portion. One end of the antenna portion is inserted into the range of the coupler and the other end of which extends to the open end of the coupler. The length of the antenna portion can be an integer times of ¼λ, achieving the effect of signal stabilization and optimization.

### BACKGROUND OF THE INVENTION

1. Field of the Invention

The present invention relates to a RFID tag with a semi-enclosed coupler, and more particularly to a RFID tag one end of the antenna portion of which is enclosed by a semi-closed coupler, the length of the antenna portion can be an integer times of ¼λ.

2. Description of the Prior Art

RFID (radio frequency identification) tag technology has been researched and developed for a quite long time, however its price is still too high to be acceptable by consumers. On top that, due to limited signal emitting and receiving distance and weak signal, it usually causes unnecessary signal aliasing. Hence, RFID tag is still unacceptable to the market. In recent years, the RFID technology has been very mature, and its research and development cost and manufacturing cost have almost been suitable for mass production and close to the requirement of the consumers', therefore, RFID tag has been growing rapidly in Taiwan and become a hot research topic. For example, as it is disclosed in the research report from Taiwan Cheng Shiu University of Science and Technology that RFID tag is structurally divided into single loop type and double loop type. The single loop type RFID tag is as shown in FIG. 1, wherein the antenna layer 90 comprises a loop coupler 91 surrounding the outer periphery thereof and a short antenna portion 92 received in the loop coupler 91. Since it is disposed in the loop coupler 91, the antenna portion 92 is restricted in length. Therefore, in case that the antenna portion 92 needs to be lengthened to meet some specific requirements, the whole length of the loop coupler 91 must also be increased accordingly. This increases not only the material cost but also the size of the RFID tag. Furthermore, the rate of size increase of the RFID tag is larger than that of the antenna portion 92, as a result of that, the RFID tag will be too big in size and long in length to be attached to miniaturized objects.

In addition, the signal emitting and receiving effect will not be stable due to the antenna portion 92 is short.

On top of that, the design that the loop coupler 91 surrounds the antenna portion 92 has the problem of causing interference between signal emitting and receiving operations, and its ground design is unable to prevent the interference.

The present invention has arisen to mitigate and/or obviate the afore-described disadvantages.

### SUMMARY OF THE INVENTION

The primary objective of the present invention is to provide a RFID tag with a semi-enclosed coupler, the coupler of the antenna layer is designed to be a semi-enclosed linear structure, and the open end of the coupler is connected to the antenna portion. One end of the antenna portion is inserted into the range of the coupler and the other end of which extends to the open end of the coupler. The length of the antenna portion can be an integer times of ¼λ, achieving the effect of signal stabilization and optimization.

### BRIEF DESCRIPTION OF THE DRAWINGS

FIG. 1 is a top view of a conventional RFID tag;

FIG. 2 is an exploded view of a conventional RFID tag;

FIG. 3 is a perspective view of a RFID tag with a semi-enclosed coupler in accordance with a first embodiment of the present invention;

FIG. 4 is a top view of a RFID tag with a semi-enclosed coupler in accordance with the first embodiment of the present invention;

FIG. 5 is a front view of a RFID tag with a semi-enclosed coupler in accordance with a second embodiment of the present invention;

FIG. 6 is a front view of a RFID tag with a semi-enclosed coupler in accordance with a third embodiment of the present invention; and

FIG. 7 is a front view of a RFID tag with a semi-enclosed coupler in accordance with a fourth embodiment of the present invention.

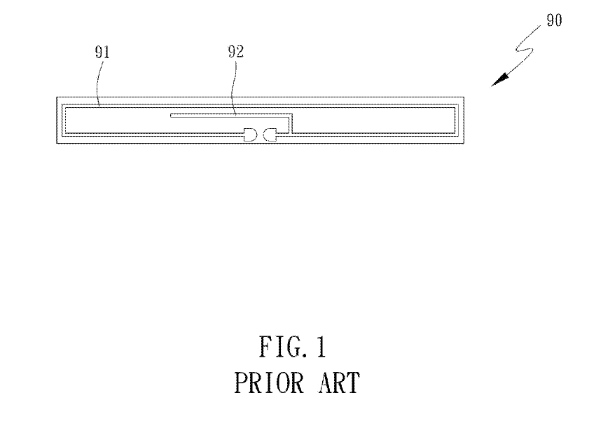

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

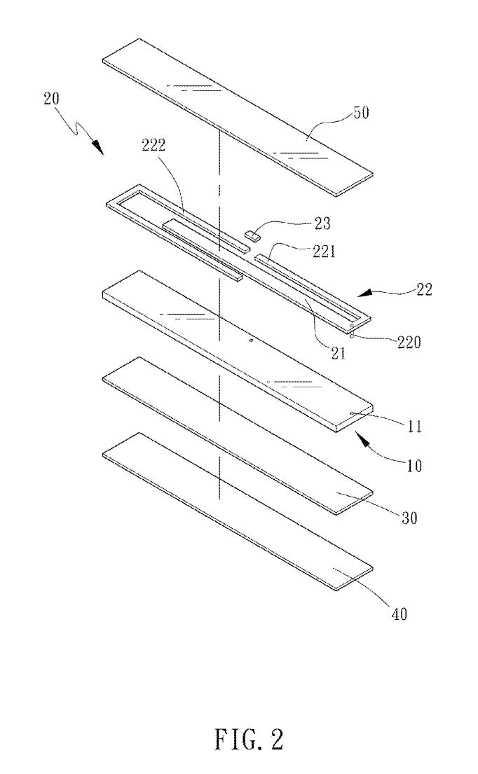

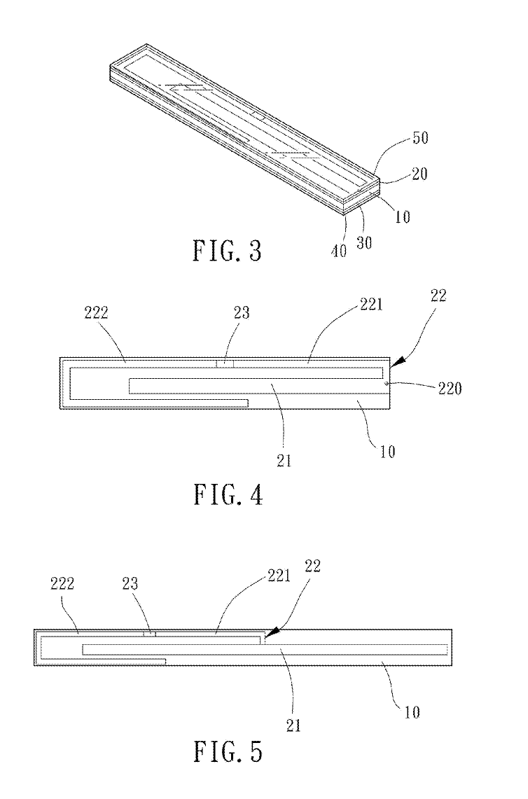

Referring to FIG. 2, RFID tag for a semi-enclosed coupler in accordance with the present invention comprises a plurality of layers laminated one another to form an integrated structure, wherein a rectangular-shaped middle dielectric layer 10, an antenna layer 20 laminated to the top of the middle dielectric layer 10, and a ground plane 30. The dielectric layer 10 is made of hard insulating material, such as PET (polyethylene terephthalate), FR4, PTFE (polytetrafluoroethylene) films or papers, for attaching the tag to the metal surface without causing interference. The antenna layer 20 is made of conductive material and formed on the middle dielectric layer 10 by printing, electroplating, eroding or any other suitable methods. The ground plane 30 is made of conductive material.

The outer surface of the RFID page is laminated with transparent protection layers 40 and 50 which are very thin plastic films.

The characteristic of the present invention is the design of the antenna layer 20, as shown in FIG. 4, the antenna layer 20 has a straight line shaped antenna portion 21 in the center thereof, the antenna portion 21 is disposed within an area enclosed by the semi-enclosed coupler 22 which is consisted of a short and straight type coupling portion 221 and an U-shaped enclosed coupling portion 222 which are disconnected from each other, so that one end of the coupler 22 is open and the other end of it is an enclosed end. The enclosed coupling portion 222 encloses one end of the antenna portion 21 but doesn't touch it (located a certain distance from it), so that the coupler 22 and the antenna portion 21 are optimally coupled. The short and straight type coupling portion 221 of the coupler 22 is connected to the other end of the antenna portion 21.

A RFID chip 23 is disposed between the coupling portions 221 and 222 of the coupler 22 in such a manner that the positive and negative terminals of the RFID chip 23 are electrically connected with the coupling portions 221 and 222, respectively.

The dielectric layer 10 is formed with a through hole 11 which is located corresponding to the conjunction between the antenna portion 21 and the coupler 22 for providing electrical connection between the antenna layer 20 and the ground plane 30, connecting them to ground, and maintaining the conjunction of the antenna portion 21 and the coupler 22 at zero voltage.

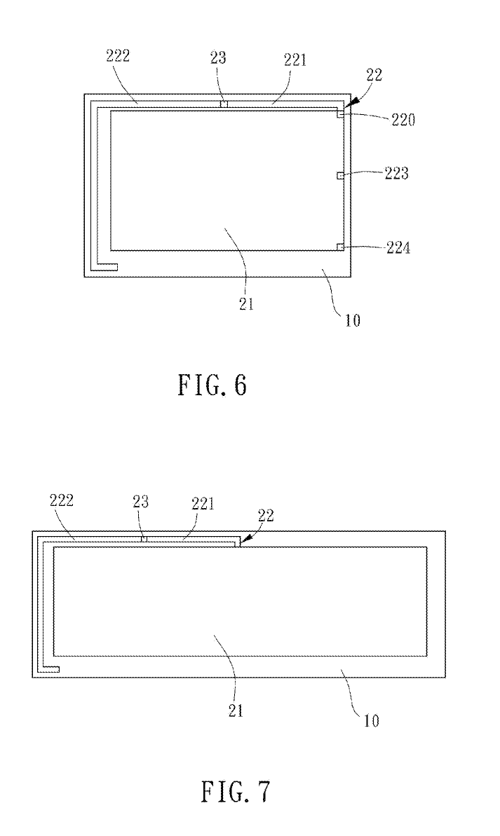

Referring further to FIGS. 4 and 5, the antenna portion 21 is a ¼λ-long micro-strip antenna, namely a micro RFID tag antenna, or it can be lengthened by a certain number of times, for example, as shown in FIG. 5, it can be ½%, the short and straight type coupling portion 221 of the coupler 22 is connected to the middle of the antenna portion 21 to meet the user's requirement or to satisfy different demand of the market. Or, as shown in FIGS. 6 and 7, the antenna portion 21 can be increased in width, the number of the through holes 11 is also increased, and the terminal end of the antenna portion is maintained at zero voltage.

Further, the coupler 22 surrounds the outer periphery of the antenna portion 21, its length can be longer than or several times of ¼λ.

With the abovementioned arrangements, the present invention has the following functions:

1, simplified structure: with the semi-enclosed coupler 22, the antenna portion 21 can be lengthened or shorten to meet different needs, it can not only provide an anticipated signal emitting and receiving effect, but also simply the structure of the antenna layer 20.

2. better matching and optimized effect: the ground design of the antenna portion 21 and the coupler 22 provides better coupling matching, and achieves the effect of conjugate and signal optimization.

3, the antenna can be differently design to meet different needs: one end of the antenna portion 21 extends out of the open end of the coupler 22, the length of the antenna portion 21 can be multiplied and the width of which can also be changed according to the change of the coupler 22, so as to meet the different needs in signal strength and stability. Hence, the applicability of the present invention is improved.

4, miniaturization: due to the simplified structure and the length variation of the antenna portion 21, the present invention can be structurally miniaturized without changing the coupler 22, making it suitable for use in big objects.

The dielectric layer is made of insulating material for enabling a back of the RFID tag to be attached to a metal surface, when a middle of the antenna portion is connected to the ground plane, a length of the antenna portion of the antenna layer is reduced to ¼λ. The antenna portion of the antenna layer is variable in width in order to be attached to a metal surface.

While we have shown and described various embodiments in accordance with the present invention, it is clear to those skilled in the art that further embodiments may be made without departing from the scope of the present invention.

What is claimed is:

1. A RFID tag with a semi-enclosed coupler, comprising:
a dielectric layer, an antenna layer laminated on a top surface of the dielectric layer, and a ground plane laminated on a bottom surface of the dielectric layer;
wherein the antenna layer includes an antenna portion and a semi-enclosed coupler, one end of the coupler encloses one end of the antenna portion in such a manner that the one end of the coupler is located a certain distance from the one end of the antenna portion, and the other end of the coupler is an open end, a RFID chip is provided on the coupler, the one end of the antenna portion is located within an area enclosed by the coupler, and the other end of the antenna is connected to the open end of the coupler, so that the antenna layer is variable in length.

2. The RFID tag with a semi-enclosed coupler as claimed in claim 1, wherein the antenna portion of the antenna layer is an integer times of ¼λ, a length of the coupler is longer than an integer times of ¼λ.

3. The RFID tag with a semi-enclosed coupler as claimed in claim 1, wherein the other end of the coupler of the antenna layer is connected to a middle portion of the antenna portion, and the one end of the coupler encloses the one end of the antenna portion in such a manner that the one end of the coupler is located a certain distance from the one end of the antenna portion.

4. The RFID tag with a semi-enclosed coupler as claimed in claim 1, wherein the other end of the coupler of the antenna layer is connected to a middle portion of the antenna portion, and the one end of the coupler encloses the one end of the antenna portion in such a manner that the one end of the coupler is located an appropriate distance from the one end of the antenna portion so that the coupler 22 and the antenna portion 21 are optimally coupled.

5. The RFID tag with a semi-enclosed coupler as claimed in claim 1, wherein the semi-enclosed coupler includes a straight coupling portion and an U-shaped enclosed coupling portion which are disconnected from each other, a RFID chip is disposed between them.

6. The RFID tag with a semi-enclosed coupler as claimed in claim 1, wherein the antenna layer is made of conductive material and formed on the dielectric layer by printing, electroplating and eroding methods, the dielectric layer is made of hard insulating material, including polyethylene terephthalate, fire resistance level 4, polytetrafluoroethylene films or papers.

7. The RFID tag with a semi-enclosed coupler as claimed in claim 1, wherein the dielectric layer is made of insulating material for enabling a back of the RFID tag to be attached to a metal surface, and the RFID tag is a micro-strip antenna.

8. The RFID tag with a semi-enclosed coupler as claimed in claim 3, wherein the dielectric layer is made of insulating material for enabling a back of the RFID tag to be attached to a metal surface, when a middle of the antenna portion is connected to the ground plane, a length of the antenna portion of the antenna layer is reduced to ¼λ.

9. The RFID tag with a semi-enclosed coupler as claimed in claim 1, wherein the antenna portion of the antenna layer is variable in width in order to be attached to a metal surface.
